(19) United States
(12) Patent Application Publication
(10) Pub. No.: US 2005/0162446 A1
(43) Pub. Date: Jul. 28, 2005

(54) Common on screen display size for multiple display formats

(76) Inventor: Charles William Worrell, Carmel, IN (US)

Correspondence Address: Joseph S Tripoli;Thomson Licensing Inc, P O Box 5312, Princeton, NJ, 08543-5312, US

(21) Appl. No.: 10/512,915

(22) PCT Filed: Apr. 29, 2003
(86) PCT No.: PCT/US03/13147

Related U.S. Application Data
(60) Provisional application No. 60/376,441, filed on Apr. 29, 2002.

(51) Int. Cl. G09G 5/00

(52) U.S. Cl. 345/660

(57) ABSTRACT

There is provided an On-Screen graphics Display (OSD) for displaying multiple display formats. The OSD includes a graphics plane, having a pre-specified number of lines, for displaying graphics in different subsets of the pre-specified number of lines. One subset is defined as a rendered area that is displayed for a display format associated with a video signal, and a second area, defined as a contingently rendered area, is rendered responsively to the display format.

### FIELD OF THE INVENTION

The present invention generally relates to display devices and, more particularly, to a display device having a common on-screen graphics display (OSD) size for supporting multiple display formats.

### BACKGROUND OF THE INVENTION

Many display devices, such as those used for analog and digital televisions, are adapted to display video data such as television programs, graphics, and text in multiple display formats. In general, video programming composed of video data, is best presented at an intended display format. When video programming, in a video signal, is displayed at a different display format than the intended display format, the displayed programming may suffer from degradation or artifacts resulting from the process of converting the video programming to a new display format.

In the case of the Advanced Television Systems Committee (ATSC) video standard, a video data receiver for a display device may receive a 480 progressive video signal (480p) in a 480p display format on one channel and a 1080 interlaced video signal (1080i) in a 1080i display format on another channel. If a display device coupled to a receiver displays these two video signals in their native display formats, separate on-screen displays (OSD) are used for displaying such things as menus or text that are rendered with the displayed video signals. This is necessary because each OSD is only capable of rendering data in one display format, hence multiple OSD are necessary for multiple display formats when each video signal corresponds to a different display format. Otherwise, an OSD must use techniques such as changing window sizes and scaling text when displaying an OSD generated menu or graphics field for a display format that the OSD does not directly support.

One approach for providing OSD generated data for different display formats has a format conversion performed on a video signal to change the signal to a new display format. A single type of OSD is therefore used for generating text and graphics information, the OSD corresponding to the new display format. Hence, any video signal that does not correspond to the new display format would undergo a format conversion so that the single type of OSD is used. The disadvantage of this approach is that a displayed video signal may be degraded by the format conversion.

A second approach for providing OSD generated data for different display formats requires that a display device maintain different OSDs, each one corresponding to a different display format. Hence, whenever a video is displayed in a specific video resolution format, the display device would use the corresponding OSD. This solution requires a display device to maintain a large memory to store data for each OSD that corresponds to a specific display format. In addition, the software to access such stored OSD information may be complex because a graphics driver, used with OSDs, must know both the current display format and whether corresponding OSD information corresponding to the display format is available.

Accordingly, it would be desirable to have a method and apparatus for maintaining a single common onscreen graphics display for multiple display formats, overcoming the problems of the prior art.

### SUMMARY OF THE INVENTION

A system and apparatus are provided for an on screen graphics display (OSD) that supports several display formats where a common graphics plane is used for each of the display formats by the OSD. The OSD generates a graphics plane having a pre-specified number of lines where graphics are displayed. The OSD separates the graphics plane into two areas, where one area is shown for a first display format and two areas are shown for a second display format.

### BRIEF DESCRIPTION OF THE DRAWINGS

FIG. 1 is a block diagram illustrating a 540 line OSD generated graphics plane for a display device for a 480p display format, according to an illustrative embodiment of the present invention;

FIG. 2 is a block diagram illustrating the 540 line OSD generated graphics plane on a display for a 1080i display format, according to an illustrative embodiment of the present invention;

FIG. 3 is a flow diagram illustrating a method for maintaining a common OSD for multiple display formats, according to an illustrative embodiment of the present invention; and

FIG. 4 is a flow diagram illustrating a method of displaying formatted data at specified font size for a specific display format.

### DETAILED DESCRIPTION OF THE INVENTION

The present invention is directed to a common onscreen graphics display (OSD) for multiple display formats. It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device.

The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. The application program optionally recognizes the attributes of a video signal, see Table I below for examples, and renders a video signal for display through the use of the OSD and a display processor. Optionally, the OSD and display processor may be combined in the same means, or may both exist as software programs implemented by a processor).

The application program may also control the operation of the OSD embodiments described in this application. The application program also may operate with a communications program (for controlling a communications interface for receiving communicated data) and a video rendering program (for controlling a display processor or operating a video driver). Alternatively, all of these control functions may be integrated into a CPU or any other type of processor for the operation of the embodiments described for this invention.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

The operation of the invention with an OSD displaying data, such as menu or text information, preferably operates with a display processor that renders video signals, such as video programming, at different display formats. The display processor receives data information from the OSD and uses such information to display menu or text information. The application program, as described above, is capable of handling the control and coordination of information between the display processor and the OSD.

The display processor processes received video signals from sources such as terrestrial antenna transmissions, cable, DSL, satellite, the Internet, or any other means capable of receiving a video signal. Preferably, the video signals comport to commonly known video standards such as ATSC, Digital Video Broadcast (DVB), Moving Picture Experts Group2 (MPEG2), National Transmission Standards Committee (NTSC) or other video signal standard.

Optionally, a communications interface, such as a modem or broadband connection, is used with the invention to obtain communicated data from a source via communications network, such as the Internet. The communicated data typically represents data such as e-mail or a web page. Such information may also be formatted in a format language as Hyper Text Markup Language (HTML), or formatting information presented with style sheets The control of the communications interface is handled via the control processor, as described above.

Once the control processor receives communicated information from the communications interface, a display processor and/or OSD is used to render the received communicated information by use of an application program called a format parser. A commonly used format parser is a program called a web browser such as OPREA™ or MOZILLA™ that renders received communicated data as a formatted text presented as a web page, particularly when communicated data is in the form of a formatted language as Hypertext Transmitted Formatted Language (HTML). The format parser reads in the HTML commands and visually renders the communicated data accordingly via the OSD and display processor. Formatted languages may also have auxiliary data objects such as graphics files, video files, and audio files that are rendered in combination with the text or menus displayed by the OSD.

The present invention provides a method an apparatus for maintaining a common OSD size over multiple display formats. By maintaining a single OSD size over multiple display formats, the disadvantages of the prior art are eliminated. For example, the need for large amounts of memory is eliminated, and video information can be displayed in its native display format, providing better picture quality.

Embodiments of the present invention are taught using the display formats available through the ATSC television standard A/53, as seen in Table I. The principles of the present invention may be used with other display formats as known in the art corresponding to other video standards. In respect to the identification of ATSC modes, information about the specific format being transmitted is located within a sequence header that resides within the video elementary stream, as used in MPEG2 and types of video data formats.

TABLE 1

| Vertical Size Limit | Horizontal Size | Aspect Ratio | | Progressive |
|---|---|---|---|---|
| (Lines) | Limit (Lines) | Information | Frame Rate (Hz) | Scan |
| 1080 | 1920 | Square Sample, 16:9 | 23.976, 24, 29.97, 30 | Yes |
| | | | 23.976, 24 | No |
| 720 | 1280 | Square Sample, 16:9 | 23.976, 24, 29.97, 30, 59.94, 60 | Yes |
| 480 | 704 | 4:3, 16:9 | 23.976, 24, 29.97, 30, 59.94, 60 | Yes |
| | | | 29.97, 30 | No |
| | 640 | Square Sample, 4:3 | 23.976, 24, 29.97, 30, 59.94, 60 | Yes |
| | | | 29.97, 30 | No |

The described embodiments of the present invention make use of the ATSC based display formats of 480p and 1080i, although other display formats may be used.

In one embodiment of the present invention, an OSD generates a graphics plane that occupies an area of 540 lines on the screen of a display device. The graphics plane is defined as a pre-selected number of lines that are located at a particular anchor location. These locations define the area of the graphics plane relative to the screen presented by a display device. For example, a display device may be capable of generating 1080 lines in a 1080p display format, and a 540 line graphics plane would have an anchor location from the 60 lines from the bottom of the rendered screen, although lines may be selected. Alternatively, a point relating to a coordinate system may be used to describe the area representing the screen of a display device. Hence, an anchor location could occupy a point at (0,0), where the graphics plane is situated relative to the screen of the display device, although other points may be selected the point of an anchor location.

Once an anchor location is defined, the OSD generated graphics plane would be separated into at least two areas with the anchor location marking the area of separation. One area of the graphics plane, as always displayed by the OSD, is the rendered area, and a second area, separated by the anchor location, is the contingently rendered area, being optionally displayed. Depending on the display format, the OSD may display information, render transparent, or a display various colors in the different areas of the graphics plane.

For example, an OSD capable of generating a graphics plane of 540 lines uses the upper 480 lines above of an anchor location (rendered area) for a displayed user interface. Below the anchor location are 60 lines (contingently rendered area) that are presented in a 1080i display format mode. Those 60 lines would then be rendered as transparent or the same color as the last few lines of the area above, in this example. If a display format is not capable of displaying 540 lines, as in the case of a 480p, those 60 lines below the anchor location would not have to be rendered as the display device would only show the OSD information pertaining to the area occupying 480 lines. This technique would give the appearance of having the “same” OSD for both display formats.

This technique in the 1080i mode, describes the OSD as appearing to be slightly compressed compared to 480p mode, as those 540 lines fill the space that was occupied by just 480 lines in 480p mode, but the same OSD information is used for both display formats because the lines below the anchor location are not shown for the 480p mode.

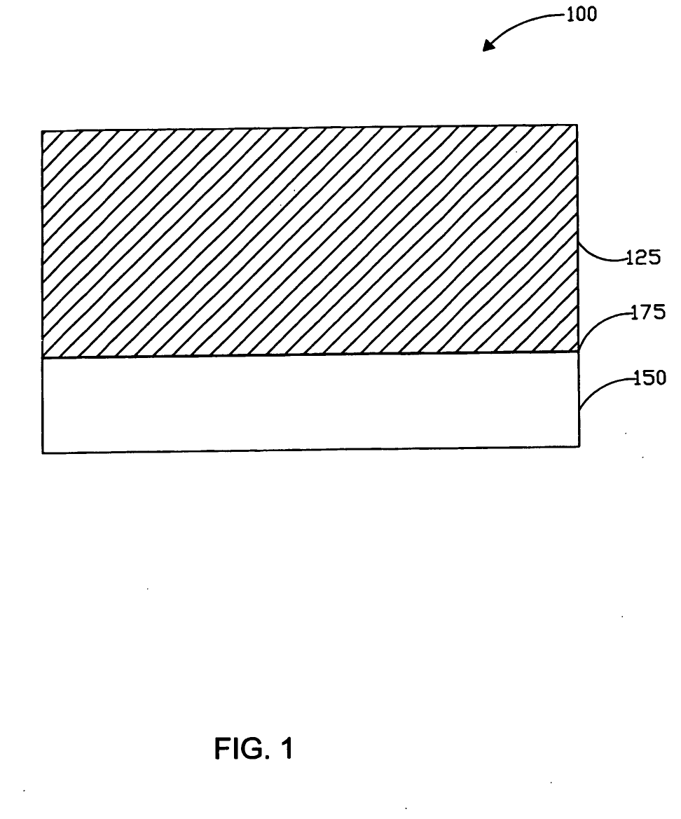

FIG. 1 is a block diagram illustrating a 540 line graphics plane 100 generated by an OSD on a display device at 480p, according to an illustrative embodiment of the present invention. The lower 60 lines, as contingently rendered area 150, are not displayed and the upper 480 lines of the graphics plane as rendered area 125 fill the display device screen. It is to be appreciated that the amount of video that is cropped off of the screen is exaggerated for the purpose of illustration. Anchor location 175 is shown as the separation between rendered area 125 and contingently rendered area 150, dividing graphics plane 100 into displayed and non-displayed areas.

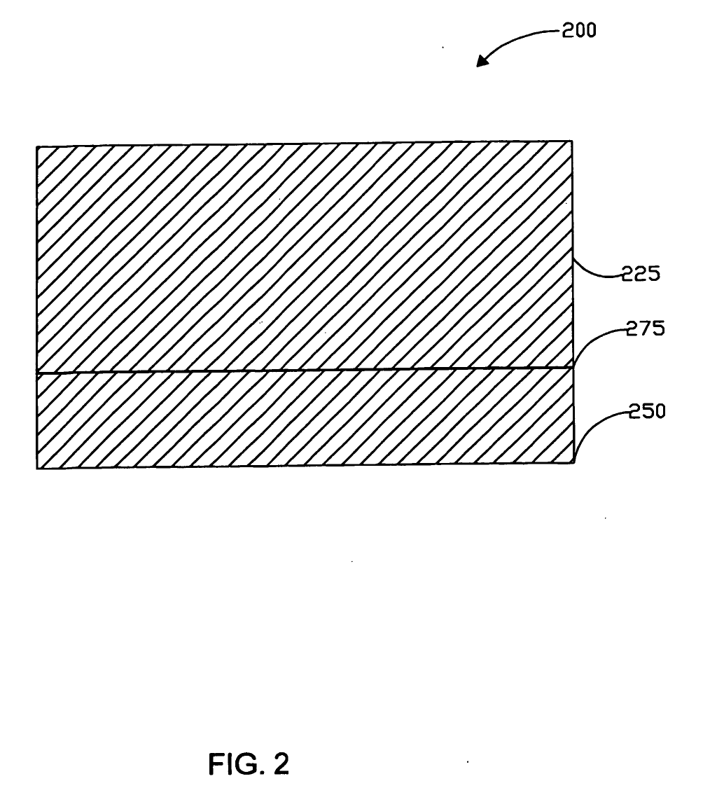

Conversely, if the display device were running at a display format of 1080i, the entire 540-line area of graphics plane 200 is displayed on screen by the OSD. FIG. 2 is a diagram illustrating the 540-line area used by the OSD of FIG. 1 for a display device in a display format of 1080i, according to an illustrative embodiment of the present invention where contingently rendered area 250 and rendered area 225 are both presented on a display device.

As shown in FIGS. 1 and 2, the OSD keeps a sense of uniformity from display format to display format simply by rendering the bottom 60 lines of the contingently rendered area 250 the same color as the lower portion of the top 480 lines comprising rendered area 225. Anchor location 275 representing the boundaries of the two rendered areas, as shown for illustrative purposes for this embodiment. Preferably, anchor location 275 is not rendered on the video display, although the representative boundary may be rendered.

An alternative technique for rendering graphics plane 200 is to render transparent lines at the top and bottom of the OSD so it appears to “float”. The final 60 lines of contingently rendered area 250 are rendered transparent as well, again making the OSD generated graphics plane 200 appear virtually identical from display format to another.

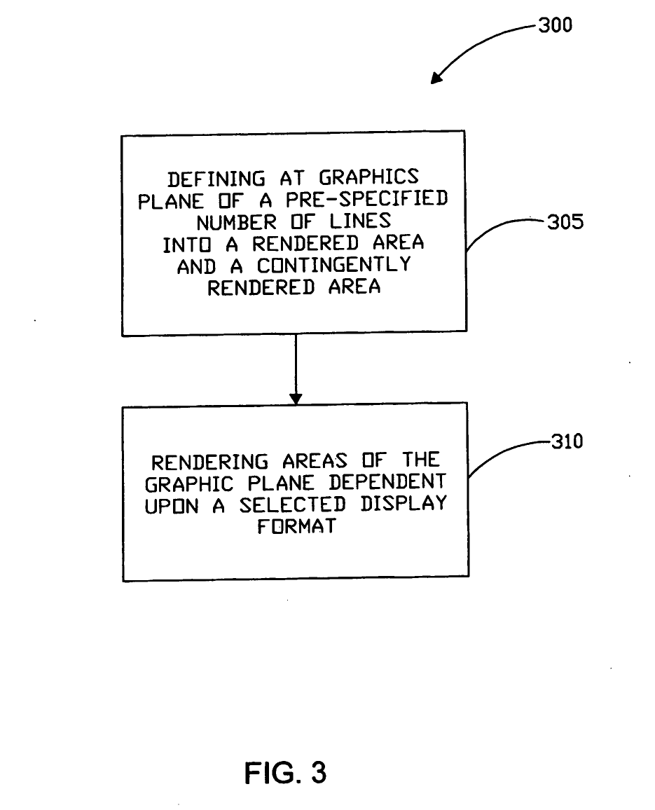

FIG. 3 is a flow diagram 300 illustrating a method for maintaining a common On-Screen graphics Display (OSD) for multiple display formats, according to an illustrative embodiment of the present invention.

A graphics plane is provided, having a pre-specified number of lines, for displaying graphics (step 305). The graphics plane is divided into two areas (also referred to as regions), for an OSD, where a first subset of the pre-specified number of lines is shown continuously as a rendered area 125 and a second subset of a pre-specified number of lines is rendered depending on a selected display format as a contingently rendered area 150.

Preferably, but not necessarily, a first or second region is anchored at an anchor location of 0,0 or at a specified screen line on a display screen or graphics plane 100. It is to be appreciated that the first subset (and/or any other subsets in the case of more than two subsets) of the pre-specified number of lines of a rendered or contingently rendered area may be disposed anywhere within the graphics plane. For example, the first contingently rendered area may be disposed at an upper portion of the graphics plane, a central or off-central portion of the graphics plane, or a lower portion of the graphics plane. Preferably, but not necessarily, the first subset as rendered area 125 is disposed at the upper portion of the graphics plane.

In a preferred embodiment of the present invention, the pre-specified number of lines defining graphics plane 100 equals 540 lines, the first native display format is a 1080i display format (as 1080i is rendered in 540 lines), the second native display format is a 480p display format, rendered as 480 lines. It is to be appreciated that the present invention is not limited to 480p and 1080i display formats and thus other display formats and other numbers and subsets of lines may be employed in an OSD according to the principles of the present invention.

Once a display format for the OSD is determined, the pre-specified numbers of lines not included in rendered area 125 are rendered as transparent, those lines being contingently rendered area 150 occupying the second region (step 310). It is to be appreciated that lines on a display screen that are not part of the graphics plane 1100 may be rendered as the same color of rendered area 125 or contingently rendered area 150. This may be the case if graphics plane 100 does not completely cover the display area of a display device. Other rendering approaches may also be employed in an OSD in accordance with the principles of the present invention.

As noted above, a graphics plane may be constructed with multiple anchor locations with multiple rendered and contingently rendered areas. For instance, a graphics plane is broken into three regions, one rendered area and two contingently rendered areas. The separation between the regions would be anchoring locations. When a display format is shown, having a high amount of displayed lines as 1080p, all the areas would be rendered. If a display format of 720p is selected, two areas are rendered (one rendered area and one contingently rendered area). When 480p as a display format is selected; only the rendered area is displayed. Preferably, when multiple areas are rendered, a user would not perceive the areas as being separate.

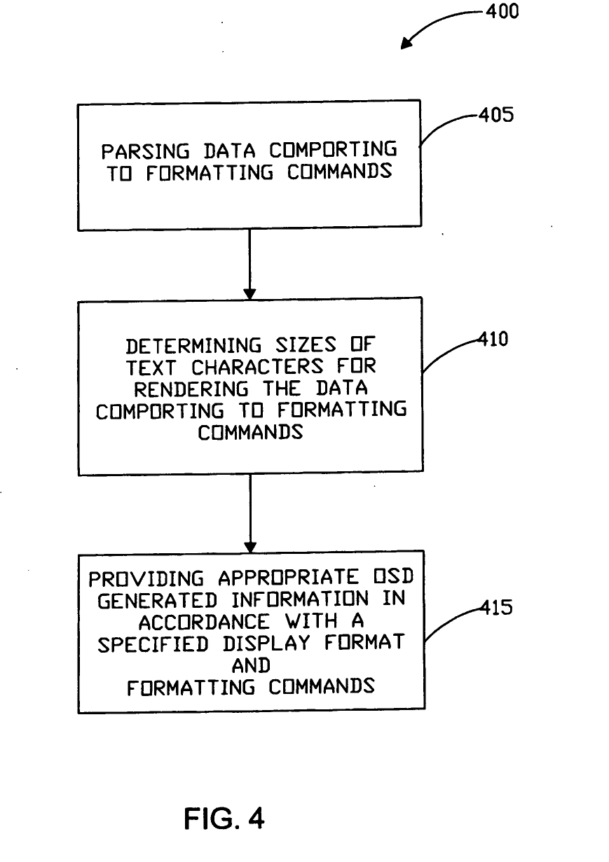

FIG. 4 illustrates a flow diagram 400 of an additional embodiment of the present invention of a method having an OSD generate menus or web page data by keeping character sizes and styles consistent between different display formats. In this embodiment, an OSD works with a format parser to consider the current display format and the type of data necessary to generate communicated data representing a web page or e-mail.

The communicated data, preferably coded in HTML, has format commands that are used for generating a representation of a web page or e-mail. The format commands determine the layout of the communicated data when rendered by the format parser. One example of a format command is the FONT command used in HTML, which defines the attributes of displayed text, such as font face, size, color, weight, and point-size, terms as well understood in the art. Other types of format commands are used to determine where text is displayed, and/or what type of web objects (pictures, video data, audio data) are shown on the generated web page. The OSD with the format parser use these format commands to generate and display the elements of a web page or e-mail.

When different display formats are selected for a display device, the rendered text of a web page is generated at the native font size or the size specified in the HTML code. Hence the text of a web page may appear larger in one display format, and smaller in a second display format that uses more display lines because such font size commands are not scaled according to different display formats. The instant embodiment of the invention uses information in the HTML commands to provide the appropriate font size for the characters generated by an OSD, so the generated OSD video data appears consistent between display formats, as the text size remains relatively in the same size from display format to display format.

In step 405, a format parser (such as a web browser), is used to read in communicated data, for example from a web site, comporting to formatting commands (as HTML) used to generate displayed information resembling a web site. In the present example, the communicated data read is in HTML code with associated web objects (pictures, graphics, and the like).

In step 410, the format parser determines character sizes (point size) for rendering a web page in accordance with formatting commands in the received data by reading formatting commands. FONT SIZE is a format command that may be processed by the format parser. The OSD is used with the format parser to determine the current display format of the display device. In the present embodiment, the current display format is 480p and this display information is obtained by the OSD by operating in conjunction with a display processor that renders video image information. The OSD then compares the character size specified for text in a format command against the specified character sizes used for 480p display format; with graphic character information stored as graphics data in the OSD. Such an association can be accomplished using a look up table, stored in a processor, as shown in Table 2, or by scaling characters from a base character set into larger or smaller sizes using scaling techniques via the OSD. After the comparison is performed, the OSD selects the appropriate font size for the text to be rendered.

Table 2 lists the font sizes of characters (point sizes) as specified in the original FONT SIZE format command, such as in a HTML document, that are matched against the font size specified for a display format. Optionally, the font size may also correspond to the font style (for example, Arial, New York Times, Universal, and the like) where each font style may use other values than presented in Table II.

TABLE II

| Font Size | 480i | 480p | 720p | 1080i | 1080p |
|---|---|---|---|---|---|
| 12 | 12 | 12 | 18 | 14 | 28 |
| 24 | 24 | 24 | 36 | 28 | 56 |
| 36 | 36 | 36 | 52 | 40 | 72 |

Step 415, has the OSD generating the page data (as displayed formatted data) with the format parser with characters at appropriate font size, as designated in TABLE 2, in accordance with a specified display format. The more lines used for the display format, the larger font size is used for the display format. The OSD is then only required to store several different sizes of fonts in an OSD, instead of storing several different sizes of fonts for each display format. Also, the OSD generates web page data at the intended font sizes, while keeping the intended perspective for a displayed web page.

As an alternative embodiment of the present invention, the OSD selects a larger font size for display formats containing fewer lines. The benefit to this the same as listed above, where an OSD only has to store several sets of fonts at different sizes, instead of storing multiple sets of font sizes each corresponding to different display formats.

Optionally, formatted text representing communicated data is rendered in the graphics plane, using the principles listed above. Hence, both the graphics plane and communicated data are rendered in association with the display format of a video signal representing video programming. This process would also be repeated for a video signal of a second display format. For example, for a video signal comporting to a 480p display format, a format command embedded in the HTML code stipulates that the text be rendered in a 12 point font size. Hence, the graphics plane is rendered as 480 lines and text is displayed in a 12 point font by the OSD. If the display format corresponding to the video signal is changed to a 1080i display format, 540 lines of the graphics plane is rendered and a 14 point font size is used for reformatting the display of communicated text. Other display formats, formatting commands, and sizes of the graphics plane may be used in accordance with the principles of the present invention.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. An On Screen Display (OSD) capable of generating a graphics plane of a pre-selected number of lines, with areas of the graphics plane being rendered in accordance with a display format corresponding to a video signal, said apparatus comprising:
means for generating a rendered area of the graphics plane; and
means for generating a contingently rendered area of the graphics plane, responsive to the display format associated with the video signal.

2. The apparatus of claim 1, wherein an anchoring location separates the generated graphics plane into the rendered area and the contingently rendered area.

3. The apparatus of claim 1, wherein the anchoring location is specified relative to the screen of a display device by at least one of: a line of the screen of the display device, and a location on the screen identified as a coordinate point.

4. The apparatus of claim 1, wherein the graphics plane includes a second contingently rendered area to support a second display format associated to a second video signal.

5. The apparatus of claim 1, wherein the generated graphics plane is 540 lines, with the rendered area being 480 lines and the contingently rendered area being 60 lines when the video signal is associated with a 1080 interlaced display (1080i) format.

6. The apparatus of claim 5, wherein only the rendered area of the generated graphics plane is displayed when the video signal is associated with a 480 line progressively scanned display format.

7. A method for generating a graphics plane of a pre-selected number of lines, with areas of the graphics plane being rendered in accordance with a display format corresponding to a video signal, the method comprising the steps comprising:
generating a rendered area of the graphics plane; and
generating a contingently rendered area of the graphics plane, responsive to the display format associated with the video signal.

8. The method of claim 7, wherein an anchoring location separates the generated graphics plane into the rendered area and the contingently rendered area.

9. The method of claim 7, wherein the anchoring location is specified relative to the screen of a display device by at least one of: a line of the screen of the display device, and a location on the screen identified as a coordinate point.

10. The method of claim 7, wherein the graphics plane includes a second contingently rendered area to support a second display format of a second video signal.

11. The method of claim 7, wherein the generated graphics plane is 540 lines, with the rendered area being 480 lines and the contingently rendered area being 60 lines when the video signal is associated with a 1080 interlaced display format.

12. The method of claim 11, wherein only the rendered area of the generated graphics plane is displayed when the video signal is associated with a 480 line progressively scanned display format.

13. The method of claim 7, comprising an additional step of:
overlaying the generated graphics plane over displayed video data representing the video signal.

14. A method for generating a graphics plane of a pre-selected number of lines, wherein areas of the graphics plane and text from communicated data are displayed in the graphics plane are rendered in accordance with a display format associated with a video signal and text is, the method comprising the steps of:
displaying a rendered area of the graphics plane in accordance with the display format associated with the video signal;
formatting the communicated text responsively to format commands in the communicated data and the display format associated with the video signal;
displaying the communicated text, wherein an attribute of the displayed communicated text differs from the format commands.

15. The method of claim 14, wherein the format of the displayed communicated text has a different font size than the font size specified in the format commands.

16. The method of claim 14, wherein the formatting step using a look up table to change an attribute of the displayed communicated text.

17. The method of claim 14, wherein communicated text comports to HTML.

18. The method of claim 14 comprising the additional steps of:
generating a contingently rendered area of the graphics plane to support a second display format associated with a second video signal;
reformatting the communicated data to the second display format of the second video signal; and
displaying the reformatted communicated data wherein a second attribute of the reformatted communicated data is displayed differently than specified in the formatting commands.

19. The method of claim 14, wherein the attribute is at least one of: font face, size, color, weight, and point-size.
